(19) United States
(12) Patent Application Publication
(10) Pub. No.: US 2004/0168613 A1
(43) Pub. Date: Sep. 2, 2004

(54) Composition and method to form a release layer

(75) Inventors: Van Xuan Hong Nguyen, Austin, TX (US); Christopher J. MacKay, Austin, TX (US); B. Jin Choi, Round Rock, TX (US)

Correspondence Address: Kenneth C. Brooks, Molecular Imprints, Inc., Legal Department, P.O. BOX 81536, Austin, TX, 78708, US

(73) Assignee: MOLECULAR IMPRINTS, INC., Austin, TX (US)

(21) Appl. No.: 10/375,832

(22) Filed: Feb. 27, 2003

(51) Int. Cl. B05D 3/02; C09K 3/00

(52) U.S. Cl. 106/287.1; 427/387

(57) ABSTRACT

The present invention provides a composition and method to form a release layer to reduce adhesion between a polymerizable layer and a substrate surface that selectively comes into contact with the polymerizable layer. The composition consists of di-functional perfluoro silane containing molecules, and mono-functional perfluoro silane containing molecules. The method features disposing a coating upon the surface from a composition having a perfluoro silane containing molecule that includes a mixture of the di-functional and mono-functional perfluoro silane containing molecules. The perfluoro silane containing molecules are connected to bonding regions of the surface to form a layer having contact regions. A sub-set of the mono-functional perfluoro silane containing molecules are attached to bonding regions positioned between bonding regions to which the di-functional perfluoro silane containing molecules are attached.

### BACKGROUND OF THE INVENTION

The field of invention relates generally to micro-fabrication of structures. More particularly, the present invention is directed to patterning substrates in furtherance of the formation of structures.

Micro-fabrication involves the fabrication of very small structures, e.g., having features on the order of micro-meters or smaller. One area in which micro-fabrication has had a sizeable impact is in the processing of integrated circuits. As the semiconductor processing industry continues to strive for larger production yields while increasing the circuits per unit area formed on a substrate, micro-fabrication becomes increasingly important. Micro-fabrication provides greater process control while allowing increased reduction of the minimum feature dimension of the structures formed. Other areas of development in which micro-fabrication has been employed include biotechnology, optical technology, mechanical systems and the like.

An exemplary micro-fabrication technique is shown in U.S. Pat. No. 6,334,960 to Willson et al. Willson et al. disclose a method of forming a relief image in a structure. The method includes providing a substrate having a transfer layer. The transfer layer is covered with a polymerizable fluid composition. An imprint device makes mechanical contact with the polymerizable fluid. The imprint device includes a relief structure, and the polymerizable fluid composition fills the relief structure. The polymerizable fluid composition is then subjected to conditions to solidify and polymerize the same, forming a solidified polymeric material on the transfer layer that contains a relief structure complimentary to that of the imprint device. The imprint device is then separated from the solid polymeric material such that a replica of the relief structure in the imprint device is formed in the solidified polymeric material. The transfer layer and the solidified polymeric material are subjected to an environment to selectively etch the transfer layer relative to the solidified polymeric material such that a relief image is formed in the transfer layer.

An important characteristic with accurately forming the pattern in the polymeric material is to reduce, if not prevent, adhesion of the polymeric material, and/or, transfer layer, to the imprint device. These are referred to as release characteristics. In this manner, the pattern recorded in the polymeric material and/or transfer layer, is not distorted during separation of the imprint device therefrom. To improve the release characteristics, Willson et al. form a release layer on the surface of the imprint device. The release layer adheres to the imprint device and to either the transfer layer or the polymeric material. Providing the transfer layer with improved release characteristics minimizes distortions in the pattern recorded into the polymeric material and/or the transfer layer that are attributable to imprint device separation.

It is desired, therefore, to improve the release characteristics of an imprint device employed in imprint lithography processes.

### SUMMARY OF THE INVENTION

The present invention provides a composition and method to form a release layer to reduce adhesion between a polymerizable layer and a substrate surface that selectively comes into contact with the polymerizable layer. The composition consists of di-functional perfluoro silane containing molecules, and mono-functional perfluoro silane containing molecules. The method features disposing a coating upon the surface from a composition having a perfluoro silane containing molecule that includes a mixture of the di-functional and mono-functional perfluoro silane molecules. The perfluoro silane molecules are connected to bonding regions of the surface to form a layer having contact regions. A sub-set of the mono-functional molecules are attached to bonding regions positioned between bonding regions to which the di-functional perfluoro silane molecules are attached. These and other embodiments are described herein.

### BRIEF DESCRIPTION OF THE DRAWINGS

FIG. 1 is a perspective view of a lithographic system in accordance with the present invention;

FIG. 2 is a simplified elevation view of a lithographic system shown in FIG. 1;

FIG. 3 is a simplified representation of material from which an imprinting layer, shown in FIG. 2, is comprised before being polymerized and cross-linked;

FIG. 4 is a simplified representation of cross-linked polymer material into which the material shown in FIG. 3 is transformed after being subjected to radiation;

FIG. 5 is a simplified elevation view of an imprint device spaced-apart from the imprinting layer, shown in FIG. 1, after patterning of the imprinting layer;

FIG. 6 is a simplified elevation view of material in an imprint device and substrate employed with the present invention in accordance with an alternate embodiment;

FIG. 7 is a schematic view of a perfluoro silane containing molecule in accordance with a first embodiment of the present invention;

FIG. 8 is a schematic view of the perfluoro silane containing molecule shown in FIG. 7 being bonded to a surface of the imprint device shown in FIGS. 1-6;

FIG. 9 is a flow diagram describing a process for creating a release layer shown in FIGS. 6-7; and

FIG. 10 is a schematic view of the perfluoro silane containing molecule shown in FIG. 7 being bonded to a surface of the imprint device shown in FIGS. 1-6 in accordance with a second embodiment of the present invention.

### DETAILED DESCRIPTION OF THE PREFERRED EMBODIMENTS

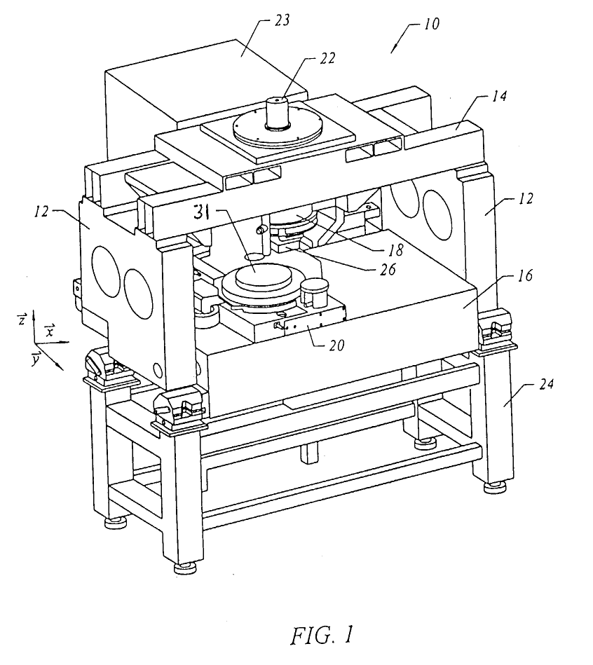

FIG. 1 depicts a lithographic system 10 in accordance with one embodiment of the present invention that includes a pair of spaced-apart bridge supports 12 having a bridge 14 and a stage support 16 extending therebetween. Bridge 14 and stage support 16 are spaced-apart. Coupled to bridge 14 is an imprint head 18, which extends from bridge 14 toward stage support 16. Disposed upon stage support 16 to face imprint head 18 is a motion stage 20. Motion stage 20 is configured to move with respect to stage support 16 along X and Y axes. A radiation source 22 is coupled to system 10 to impinge actinic radiation upon motion stage 20. As shown, radiation source 22 is coupled to bridge 14 and includes a power generator 23 connected to radiation source 22.

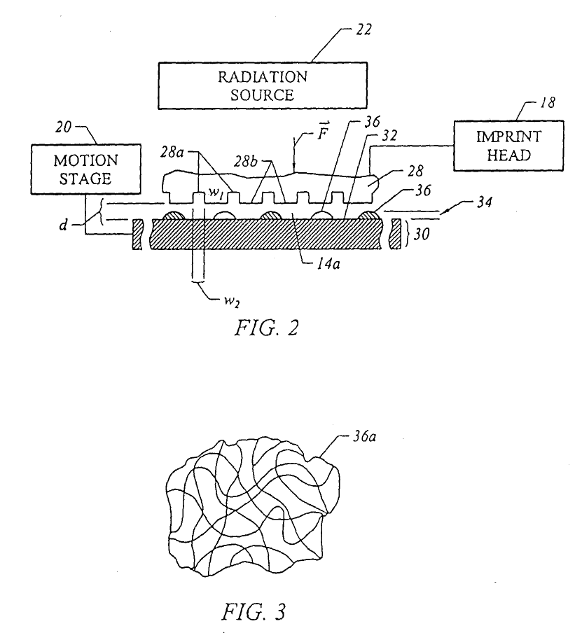

Referring to both FIGS. 1 and 2, connected to imprint head 18 is a substrate 26 having an imprint device 28 thereon. Imprint device 28 includes a plurality of features defined by a plurality of spaced-apart recessions 28a and protrusions 28b. The plurality of features defines an original pattern that is to be transferred into a wafer 31 positioned on motion stage 20. To that end, imprint head 18 is adapted to move along the Z axis and vary a distance “d” between imprint device 28 and wafer 31. In this manner, the features on imprint device 28 may be imprinted into a flowable region of wafer 31, discussed more fully below. Radiation source 22 is located so that imprint device 28 is positioned between radiation source 22 and wafer 31. As a result, imprint device 28 is fabricated from material that allows it to be substantially transparent to the radiation produced by radiation source 22.

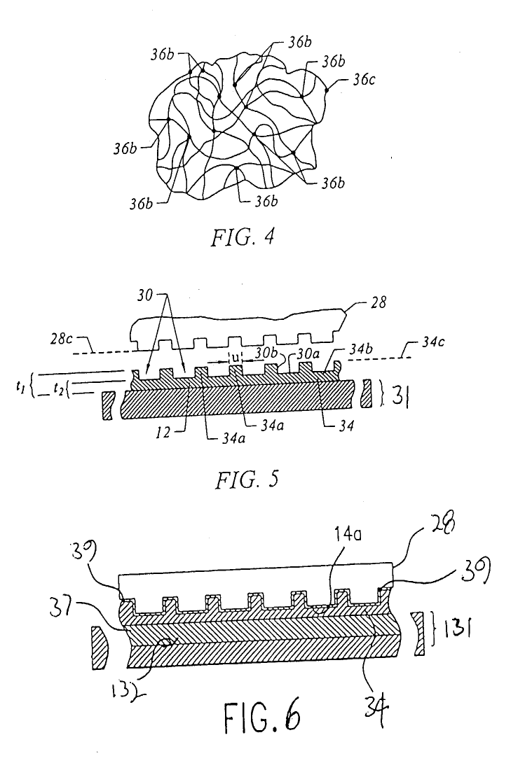

Referring to both FIGS. 2 and 3, a flowable region, such as an imprinting layer 34, is disposed on a portion of surface 32 that presents a substantially planar profile. Flowable region may be formed using any known technique such as a hot embossing process disclosed in U.S. Pat. No. 5,772,905, which is incorporated by reference in its entirety herein, or a laser assisted direct imprinting (LADI) process of the type described by Chou et al. in Ultrafast and Direct Imprint of Nanostructures in Silicon, Nature, Col. 417, pp. 835-837, June 2002. In the present embodiment, however, flowable region consists of imprinting layer 34 being deposited as a plurality of spaced-apart discrete beads 36 of material 36a on wafer 31, discussed more fully below. Imprinting layer 34 is formed from a material 36a that may be selectively polymerized and cross-linked to record the original pattern therein, defining a recorded pattern. Material 36a is shown in FIG. 4 as being cross-linked at points 36b, forming cross-linked polymer material 36c.

Referring to FIGS. 2, 3 and 5, the pattern recorded in imprinting layer 34 is produced, in part, by mechanical contact with imprint device 28. To that end, imprint head 18 reduces the distance “d” to allow imprinting layer 34 to come into mechanical contact with imprint device 28, spreading beads 36 so as to form imprinting layer 34 with a contiguous formation of material 36a over surface 32. In one embodiment, distance “d” is reduced to allow sub-portions 34a of imprinting layer 34 to ingress into and fill recessions 28a.

To facilitate filling of recessions 28a, material 36a is provided with the requisite properties to completely fill recessions 28a while covering surface 32 with a contiguous, formation of material 36a. In the present embodiment, sub-portions 34b of imprinting layer 34 in superimposition with protrusions 28b remain after the desired, usually minimum distance “d”, has been reached, leaving sub-portions 34a with a thickness t₁, and sub-portions 34b with a thickness, t₂. Thicknesses “t₁”, and “t₂” may be any thickness desired, dependent upon the application. Typically, t₁ is selected so as to be no greater than twice the width u of sub-portions 34a, i.e., t₁≦2u, shown more clearly in FIG. 5.

Referring to FIGS. 2, 3 and 4, after a desired distance “d” has been reached, radiation source 22 produces actinic radiation that polymerizes and cross-links material 36a, forming cross-linked polymer material 36c. As a result, the composition of imprinting layer 34 transforms from material 36a to material 36c, which is a solid. Specifically, material 36c is solidified to provide side 34c of imprinting layer 34 with a shape conforming to a shape of a surface. 28c of imprint device 28, shown more clearly in FIG. 5, with imprinting layer 34 having recesses 30. After imprinting layer 34 is transformed to consist of material 36c, shown in FIG. 4, imprint head 18, shown in FIG. 2, is moved to increase distance “d” so that imprint device 28 and imprinting layer 34 are spaced-apart.

Referring to FIG. 5, additional processing may be employed to complete the patterning of wafer 31. For example, wafer 31 and imprinting layer 34 may be etched to transfer the pattern of imprinting layer 34 into wafer 31, providing a patterned surface (not shown). To facilitate etching, the material from which imprinting layer 34 is formed may be varied to define a relative etch rate with respect to wafer 31, as desired. The relative etch rate of imprinting layer 34 to wafer 31 may be in a range of about 1.5:1 to about 100:1.

To that end, imprinting layer 34 may be provided with an etch differential with respect to photo-resist material (not shown) selectively disposed thereon. The photo-resist material (not shown) may be provided to further pattern imprinting layer 34, using known techniques. Any etch process may be employed, dependent upon the etch rate desired and the underlying constituents that form wafer 31 and imprinting layer 34. Exemplary etch processes may include plasma etching, reactive ion etching, chemical wet etching and the like.

Referring to FIGS. 2, 3 and 6, it may be desired to remove residual material (not shown) that may be present on imprinting layer 34 after patterning has been completed. The residual material may consist of unpolymerized material 36a, solid polymerized and cross-linked material 36c, shown in FIG. 4, material from which wafer 31 is formed, shown in FIG. 1, or a combination thereof. Further processing may be included to remove the residual material using well known techniques, e.g., argon ion milling, a plasma etch, reactive ion etching or a combination thereof. Further, removal of the material may be accomplished during any stage of the patterning. For example, removal of the residual material (not shown) may be carried out before etching the polymerized and cross-linked imprinting layer 34.

Referring to both FIGS. 1 and 2 an exemplary radiation source 22 may produce ultraviolet radiation. Other radiation sources may be employed, such as thermal, electromagnetic and the like. The selection of radiation employed to initiate the polymerization of the material in imprinting layer 34 is known to one skilled in the art and typically depends on the specific application which is desired. Furthermore, the plurality of features on imprint device 28 are shown as recessions 28a extending along a direction parallel to protrusions 28b that provide a cross-section of imprint device 28 with a shape of a battlement. However, recessions 28a and protrusions 28b may correspond to virtually any feature required to create an integrated circuit and may be as small as a few tenths of nanometers.

It may be desired to manufacture components of system 10 from materials that are thermally stable, e.g., have a thermal expansion coefficient of less than about 10 ppm/degree centigrade at about room temperature (e.g. 25 degrees Centigrade). In some embodiments, the material of construction may have a thermal expansion coefficient of less than about 10 ppm/degree Centigrade, or less than 1 ppm/degree Centigrade. To that end, bridge supports 12, bridge 14, and/or stage support 16 may be fabricated from one or more of the following materials: silicon carbide, iron alloys available under the trade-name INVAR®, or trade-name SUPER INVAR™, ceramics, including but not limited to ZERODUR® ceramic. Additionally, table 24 may be constructed to isolate the remaining components of system 10 from vibrations in the surrounding environment. An exemplary table 24 is available from Newport Corporation of Irvine, Calif.

Referring to FIGS. 1, 2 and 5, the pattern produced by the present patterning technique may be transferred into wafer 31 to provided features having aspect ratios as great as 30:1. To that end, one embodiment of imprint device 28 has recesses 28a defining an aspect ratio in a range of 1:1 to 10:1. Specifically, protrusions 28b have a width W₁ in a range of about 10 nm to about 5000 μm, and recesses 16 have a width W₂ in a range of 10 nm to about 5000 μm. As a result, imprint device 28 and/or substrate 26, may be formed from various conventional materials, such as, but not limited to, quartz, silicon, organic polymers, siloxane polymers, borosilicate glass, fluorocarbon polymers, metal, and combinations of the above.

Referring to FIGS. 1, 2 and 3, the characteristics of material 36a are important to efficiently pattern wafer 31 in light of the unique deposition process employed. As mentioned above, material 36a is deposited on wafer 31 as a plurality of discrete and spaced-apart beads 36. The combined volume of beads 36 is such that the material 36a is distributed appropriately over area of surface 32 where imprinting layer 34 is to be formed. As a result, imprinting layer 34 is spread and patterned concurrently, with the pattern being subsequently set by exposure to radiation, such as ultraviolet radiation. As a result of the deposition process it is desired that material 36a have certain characteristics to facilitate rapid and even spreading of material 36a in beads 36 over surface 32 so that the all thicknesses t₁ are substantially uniform and all thicknesses t₂ are substantially uniform. The desirable characteristics include having a viscosity approximately that of water, (H₂O), 1 to 2 centepoise (csp), or less, as well as the ability to wet surface of wafer 31 to avoid subsequent pit or hole formation after polymerization. To that end, in one example, the wettability of imprinting layer 34, as defined by the contact angle method, should be such that the angle, θ₁, is defined as follows:

0≧θ₁<75°

With these two characteristics being satisfied, imprinting layer 34 may be made sufficiently thin while avoiding formation of pits or holes in the thinner regions, such as sub-portions 34b.

Referring to FIGS. 2, 3 and 5, another characteristic that it is desired for material 36a to possess is thermal stability such that the variation in an angle Φ, measured between a nadir 30a of a recess 30 and a sidewall 30b thereof, does not vary more than 10% after being heated to 75° C. for thirty (30) minutes. Additionally, material 36a should transform to material 36c, shown in FIG. 4, i.e., polymerize and cross-link, when subjected to a pulse of radiation containing less than 5 J cm-2. In the present example, polymerization and cross-linking was determined by analyzing the infrared absorption of the “C═C” bond contained in material 36a. Additionally, it is desired that wafer surface 32 be relatively inert toward material 36a, such that less than 500 nm of surface 32 be dissolved as a result sixty seconds of contact with material 36a. It is further desired that the wetting of imprint device 28 by imprinting layer 34 be minimized. To that end, the wetting angle, θ₂, should be greater than 75°. Finally, should it be desired to vary an etch rate differential between imprinting layer 34 and wafer 31 an exemplary embodiment of the present invention would demonstrate an etch rate that is 20% less than the etch rate of an optical photo-resist (not shown) exposed to an oxygen plasma.

The constituent components that form material 36a to provide the aforementioned characteristics may differ. This results from wafer 31 being formed from a number of different materials. As a result, the chemical composition of surface 32 varies dependent upon the material from which wafer 31 is formed. For example, wafer 31 may be formed from silicon, plastics, gallium arsenide, mercury telluride, and composites thereof. Additionally, wafer 31 may include one or more layers in sub-portion 34b, e.g., dielectric layer, metal layers, semiconductor layer and the like.

Referring to FIGS. 2 and 3, in one embodiment of the present invention the constituent components of material 36a consist of acrylated monomers or methacrylated monomers that are not silyated, a cross-linking agent, and an initiator. The non-silyated acryl or methacryl monomers are selected to provide material 36a with a minimal viscosity, e.g., viscosity approximating the viscosity of water (1-2 cps) or less. The cross-linking agent is included, even though the size of these molecules increases the viscosity of material 36a, to cross-link the molecules of the non-silyated monomers, providing material 36a with the properties to record a pattern thereon having very small feature sizes, on the order of a few nanometers and to provide the aforementioned thermal stability for further processing. To that end, the initiator is provided to produce a free radical reaction in response to radiation, causing the non-silyated monomers and the cross-linking agent to polymerize and cross-link, forming a cross-linked polymer material 36c, shown in FIG. 4. In the present example, a photo-initiator responsive to ultraviolet radiation is employed. In addition, if desired, a silyated monomer may also be included in material 36a to control the etch rate of the result cross-linked polymer material 36c, without substantially affecting the viscosity of material 36a.

Examples of non-silyated monomers include, but are not limited to, butyl acrylate, methyl acrylate, methyl methacrylate, or mixtures thereof. The non-silyated monomer may make up approximately 25 to 60% by weight of material 36a. It is believed that the monomer provides adhesion to an underlying organic transfer layer, discussed more fully below.

The cross-linking agent is a monomer that includes two or more polymerizable groups. In one embodiment, polyfunctional siloxane derivatives may be used as a cross-linking agent. An example of a polyfunctional siloxane derivative is 1,3-bis(3-methacryloxypropyl)-tetramethyl disiloxane. Another suitable cross-linking agent consists of ethylene diol diacrylate. The cross-linking agent may be present in material 36a in amounts of up to 20% by weight, but is more typically present in an amount of 5 to 15% by weight.

The initiator may be any component that initiates a free radical reaction in response to radiation, produced by radiation source 22, impinging thereupon and being absorbed thereby. Suitable initiators may include, but are not limited to, photo-initiators such as 1-hydroxycyclohexyl phenyl ketone or phenylbis(2,4,6-trimethyl benzoyl) phosphine oxide. The initiator may be present in material 36a in amounts of up to 5% by weight, but is typically present in an amount of 1 to 4% by weight.

Were it desired to include silylated monomers in material 36a, suitable silylated monomers may include, but are not limited to, silyl-acryloxy and silyl methacryloxy derivatives. Specific examples are methacryloxypropyl tris(tri-methylsiloxy)silane and (3-acryloxypropyl)tris(tri-methoxysiloxy)-silane. Silylated monomers may be present in material 36a amounts from 25 to 50% by weight. The curable liquid may also include a dimethyl siloxane derivative. Examples of dimethyl siloxane derivatives include, but are not limited to, (acryloxypropyl) methylsiloxane dimethylsiloxane copolymer.

Referring to both FIGS. 1 and 2, exemplary compositions for material 36a are as follows:

### COMPOSITION 1

### n-butyl acrylate+(3-acryloxypropyltristrimethylsiloxy)silane+1,3-bis(3-methacryloxypropyl)tetramethyldisiloxane

### COMPOSITION 2

### t-n-butyl acrylate+(3-acryloxypropyltristrimethylsiloxy)silane+Ethylene diol diacrylate

### COMPOSITION 3

### t-butyl acrylate+methacryloxypropylpentamethyldisiloxane+1,3-bis(3-methacryloxypropyl)tetramethyldisiloxane

The above-identified compositions also include stabilizers that are well known in the chemical art to increase the operational life, as well as initiators.

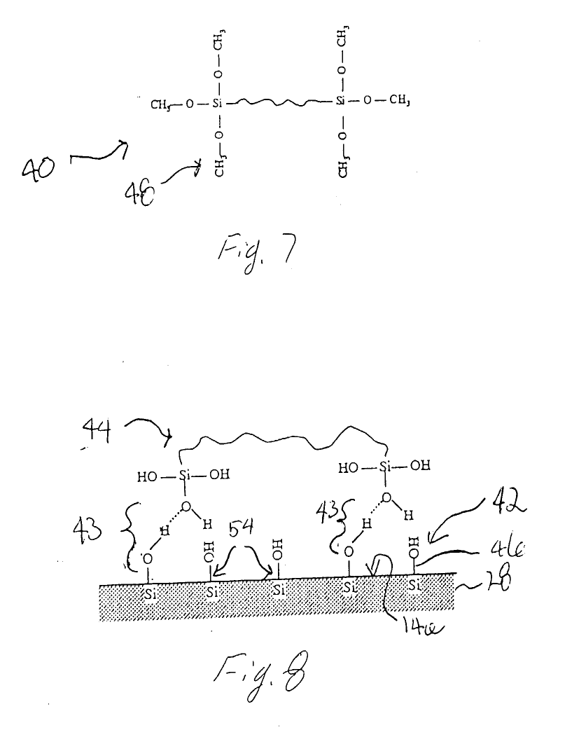

Referring to FIGS. 2 and 6, employing the compositions described above in material. 36a, shown in FIG. 3, to facilitate imprint lithography is achieved by defining a surface 132 of wafer 131 with a planarization layer 37. The primary function of planarization layer 37 is to ensure that surface 132 is planar. To that end, planarization layer 37 may be formed from a number of differing materials, such as, for example, thermoset polymers, thermoplastic polymers, polyepoxies, polyamides, polyurethanes, polycarbonates, polyesters, and combinations thereof. Planarization layer 37 is fabricated in such a manner so as to possess a continuous, smooth, relatively defect-free surface that may exhibit excellent adhesion to the imprinting layer 34.

Additionally, to ensure that imprinting layer 34 does not adhere to imprint device 28, surface 14a may be treated with a modifying agent. As a result, the imprinting layer 34 is located between planarization layer 37 and the modifying agent. One such modifying. agent is a release layer 39. Release layer 39 and other surface modifying agents, may be applied using any known process. For example, processing techniques may include chemical vapor deposition method, physical vapor deposition, atomic layer deposition or various other techniques, brazing and the like.

Referring to FIGS. 6, 7 and 8, an exemplary release layer 39 is formed from perfluoro silane containing molecules 40 sold under the trade-names FLUOROSYL™ FSD 2500 and FLUOROSYL™ FSD 4500, which are available from Cytonix Corporation located in Beltsville, Md. The perfluoro silane molecules 40 connect to surface 14a at bonding regions 42 forming covalent bonds included in covalent bonding group 43, as well as defining contact regions 44. Covalent bonding group 43 fixedly attaches di-functional perfluoro silane molecules 40 to surface 14a. Contact regions 44 are positioned to be selectively placed in contact with imprinting layer 34.

The chemical characteristics of bonding regions 42 are dependent upon, inter alia, the material from which surface 14a is formed. In the present example, surface 14a is formed from silicon, Si, and typically has a hydroxyl group bonded thereto. The hydroxyl group results from cleaning imprint device 28 with a a strong acid-oxidizing solution. As a result, bonding regions 42 include silicon-hydroxyl groups 46. The chemical characteristics of bonding groups 48 of the perfluoro silane containing molecules 40 are also dependent upon the perfluoro silane molecule employed, which, in the present example, is a methoxy group. It is believed that groups 46 and groups 48 react to covalently bond perfluoro silane containing molecules 40 to surface 14a through a condensation reaction vis-a-vis formation of covalent bonding groups 43.

Referring to FIGS. 1, 6, 7 and 9, one process employed to create release layer 39 includes immersing substrate 26 into a liquid solution (not shown) of perfluoro silane containing molecules 40 at step 100. The solution includes a fluorinated solvent, such as C₅F₁₃C₂H₄SiCl₃. The molarity of the perfluoro silane containing molecules 40 in solution is in the range of 0.1 to 1 millimolar. At step 102, substrate 26 remains in the solution for a time sufficient to leave a film of the perfluoro silane containing molecules 40 upon surface 14a once substrate 26 is removed therefrom. In the present example, substrate 26 is immersed into the solution for a period of 1 to 15 minutes. Thereafter, at step 104, substrate 26 is removed from the solution. At step 106, the film of perfluoro silane containing molecules 40 is annealed at a temperature in a range of 100° Celsius to 150° Celsius for a period of time ranging from 20 to 40 minutes. This may be done by placing substrate 26 in an oven or other thermally controlled environment.

With the present process, release layer 39 is formed to have a monomolecular structure, i.e., the thickness of release layer 39 is approximately equal to a length of one molecule of perfluoro silane containing molecules 40. Perfluoro silane containing molecules 40 in release layer 39 form a wetting angle with respect to surface 14a in a range of 90°-115°. The wetting angle is employed as a measure of the suitability of release layer 39. Specifically, were the wetting angle to fall outside of the aforementioned range, release layer 39 would be considered unsuitable for use in imprint lithography. As a result, either imprint device 28 would be discarded or provided with a new release layer 39. As a result, by periodically measuring the wetting angle, the operational life of imprint device 28 may be determined.

Referring to FIG. 8, one manner in which to increase the operational life of imprint device 28 is to form release layer 39 from a mixture of di-functional and mono-functional perfluoro silane containing molecules. It is believed that the characteristics of di-functional molecules results in an undesirable number of unreacted bonding regions, shown as 54. The unreacted bonding regions 54 are often positioned between covalent bonding groups 43 and are, therefore, located between opposed ends of di-functional molecules 40 and surface 14a.

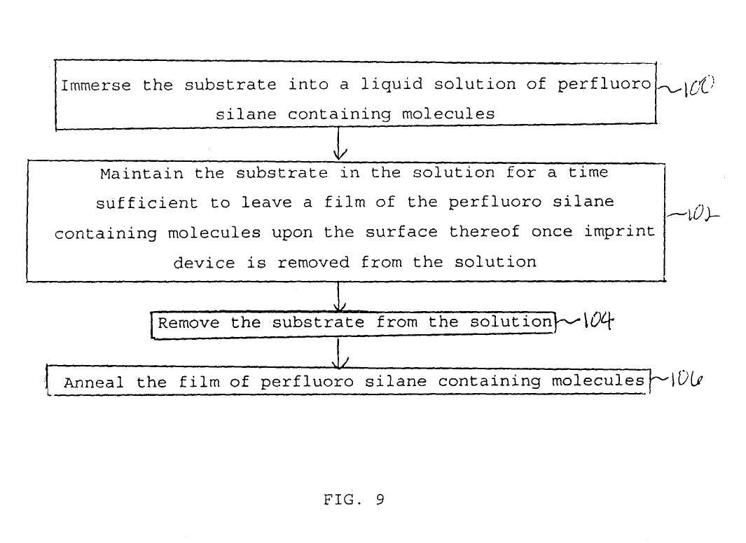

Referring to FIGS. 7, 8 and 10, mono-functional perfluoro silane containing molecules 60 are smaller in size than the di-functional perfluoro silane containing molecules 40. It is believed that the relative smallness, of the mono-functional perfluoro silane containing molecules 60 allows the same to attach to silicon groups of un-reacted bonding regions 54. This results in greater coverage of surface 14a of imprint device 28 with perfluoro silane containing molecules.

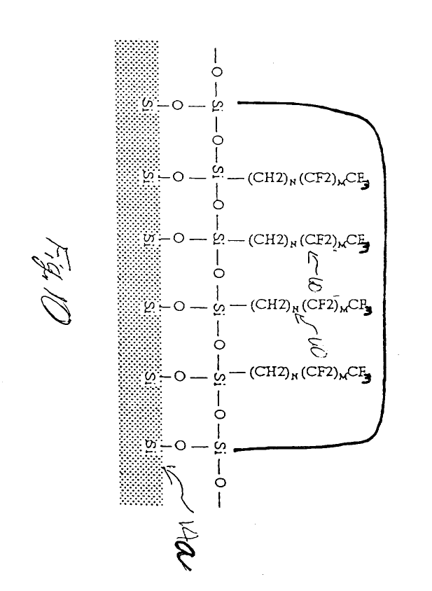

The mono-functional perfluoro containing molecules 60 may include molecules from the following chemical families: mono-functional perfluoro chlorosilanes, mono-functional perfluoro methoxysilanes, and mono-functional perfluoro ethoxysilanes. Exemplary mono-functional perfluoro containing molecules 60 employed have the following general formula R₃Si(CH₂)_{N}(CF₂)_{M}CF₃, where R₃ is a Cl atom, an OCH₃ group, or a OCH₂CH₃ group and N and M are integers. A specific example of mono-functional perfluoro containing molecules 60 is tridecafluoro-1,1,2,2-tetrahydrooctyl trichlorosilane and FM660 from Cytnoix Corporation of Beltsville, Md. Release layer 39, shown in FIG. 6, may formed from a mixture of di-functional and mono-functional perfluoro containing molecules and applied to imprint device 28 as described above, with respect to FIG. 9. The liquid solution differs only in that it contains a 1:1 mixture of the di-functional and mono-functional perfluoro silane molecules.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

What is claimed is:

1. A composition to coat a substrate, said composition comprising:
di-functional perfluoro silane containing molecules; and
mono-functional perfluoro silane containing molecules.

2. The composition as recited in claim 1 wherein said substrate includes a surface having bonding regions and said di-functional and mono-functional perfluoro silane containing molecules connect to a said bonding regions, forming covalent bonding groups, with said di-functional perfluoro silane containing molecules forming contact regions of fluorinated chains of molecules, with said covalent bonding groups being positioned between said surface and said contact regions.

3. The composition as recited in claim 1 wherein said di-functional perfluoro silane containing molecules are selected from a set of molecules consisting essentially of FLUOROSYL™ FSD 2500 and FLUOROSYL™ FSD 4500.

4. The composition as recited in claim 1 wherein said mono-functional perfluoro silane containing molecules are selected from a set of molecules consisting essentially of trimethoxysilanes, triethoxysilanes, trichlorosilanes and a group represented by the general formula R₃Si(CH₂)_{N}(CF₂)_{M}CF₃, where R₃ is a Cl atom, an OCH₃ group, or an OCH₂CH₃ group.

5. The composition as recited in claim 1 wherein said di-functional perfluoro silane containing molecules and said mono-functional perfluoro silane containing molecules form a wetting angle, with respect to said substrate, in a range of 90°-115°.

6. The composition as recited in claim 1 wherein a sub-set of said mono-functional perfluoro silane containing molecules are attached to bonding regions positioned between bonding regions to which said di-functional perfluoro silane containing molecules are bonded.

7. The composition as recited in claim 1 wherein said dual-functional and mono-functional perfluoro silane containing molecules form a layer on said surface, with said layer having a thickness of approximately equal to a length of one molecule of said di-functional perfluoro silane containing molecules.

8. A composition, disposed on a substrate having a surface including bonding regions, said composition comprising:
di-functional perfluoro silane containing molecules; and
mono-functional perfluoro silane containing molecules, with said di-functional and mono-functional perfluoro silane containing molecules connecting to said bonding regions forming covalent bonding groups and said di-functional perfluoro silane containing molecules forming contact regions of fluorinated chains of molecules, said covalent bonding groups being positioned between said surface and said contact regions and a sub-set of said mono-functional perfluoro silane containing molecules being bonded to bonding regions positioned between bonding regions to which said di-functional perfluoro silane containing molecules are bonded.

9. The composition as recited in claim 8 wherein said mono-functional perfluoro silane containing molecules are selected from a set of molecules consisting essentially of trimethoxysilanes, triethoxysilanes, trichlorosilanes and a group represented by the general formula R₃Si(CH₂)_{N}(CF₂)_{M}CF₃, where R₃ is a Cl atom, an OCH₃ group, or an OCH₂CH₃ group.

10. The composition as recited in claim 9 wherein said dual-functional and mono-functional perfluoro silane containing molecules form a layer on said surface, with said layer having a thickness of approximately equal to a length of one molecule of said di-functional perfluoro silane containing molecules.

11. The composition as recited in claim 10 wherein said mono-functional perfluoro silane containing molecules form a wetting angle, with respect to said substrate, in a range of 90°-115°.

12. The composition as recited in claim 11 wherein said di-functional perfluoro silane containing molecules are selected from a set of molecules consisting essentially of FLUOROSYL™ FSD 2500 and FLUOROSYL™ FSD 4500.

13. The composition as recited in claim 12 wherein said di-functional perfluoro silane containing molecules form a wetting angle, with respect to said substrate, in a range of 90°-115°.

14. A method of coating a substrate having a surface with bonding regions, said method comprising:
forming a liquid solution of perfluoro silane containing molecules that includes di-functional perfluoro silane containing molecules and mono-functional perfluoro silane containing molecules;
placing said substrate in said solution for sufficient time to leave a film of said perfluoro silane containing molecules upon said substrate; and
annealing said substrate, after removal from said solution, to form said coating on said substrate by covalently attaching said perfluoro silane containing molecules to said bonding regions forming covalent bonding groups.

15. The method as recited in claim 14 wherein annealing further includes providing coating with contact regions having fluorinated chains of molecules, with said covalent bonding groups being positioned between said surface and said contact regions.

16. The method as recited in claim 14 wherein placing further includes providing said film with a thickness approximately equal to a length of one molecule of said di-functional perfluoro silane containing molecules.

17. The method as recited in claim 14 wherein placing said substrate further includes placing said substrate in said solution for a period of time ranging from 1 to 15 minutes.

18. The method as recited in claim 14 wherein annealing said substrate further includes baking said substrate at 130° Celsius for an additional period of time in a range of 20 to 40 minutes.

19. The method as recited in claim 14 wherein forming further includes providing said di-functional perfluoro silane containing molecules from molecules selected from a set of molecules consisting essentially of FLUOROSYL™ FSD 2500 and FLUOROSYL™ FSD 4500 and providing mono-functional perfluoro silane containing molecules from a set of molecules consisting essentially of trimethoxysilanes, triethoxysilanes, trichlorosilanes and a group represented by the general formula R₃Si(CH₂)_{N}(CF₂)_{M}CF₃, where R₃ is a Cl atom, an OCH₃ group, or an OCH₂CH₃ group.

20. The method as recited in claim 14 wherein forming further includes bonding a sub-set of said mono-functional perfluoro silane containing molecules to bonding regions positioned between bonding regions to which said di-functional perfluoro silane containing molecules are bonded.
